(19) United States
(12) Patent Application Publication
(10) Pub. No.: US 2004/0093349 A1
(43) Pub. Date: May 13, 2004

(54) System for and method of capture, analysis, management, and access of disparate types and sources of media, biometric, and database information

(75) Inventors: Rimas Buinevicius, Madison, WI (US); Krishna Pendyala, Allison Park, PA (US)

Correspondence Address: FOLEY & LARDNER, 777 EAST WISCONSIN AVENUE, SUITE 3800, MILWAUKEE, WI, 53202-5308, US

(73) Assignee: Sonic Foundry, Inc.

(21) Appl. No.: 09/995,292

(22) Filed: Nov. 27, 2001

(51) Int. Cl. G06F 7/00

(52) U.S. Cl. 707/104.1

(57) ABSTRACT

The system and method herein capture, analyze, manage, and access disparate types and sources of media, biometric, and database information. The system and method build a unified and intelligent time-based view of individuals, regardless of data source or type. This view is possible by capturing media, biometric, and database information; processing that multi-modal information to extract, analyze and quickly sort through large volumes of digital information; and providing a user interface that can be configured to retrieve, view, manage, compare, and annotate captured information and analysis.

### FIELD OF THE INVENTION

The present invention relates generally to computerized signal processing methods and systems. Further, an exemplary embodiment of the present invention relates to a system for and a method of capture, analysis, management, and access of disparate types and sources of media, biometric, and database information.

### BACKGROUND OF THE INVENTION

Heretofore, discrete systems have been used for capturing media, such as, audio or video. Discrete systems have also been used to capturing biometric information. Examples of conventional media capturing systems can include video cameras and audio microphones. Such known systems have been used in security or surveillance systems to detect video images and/or sounds. For example, video cameras have been used at public shopping places to monitor customer behavior and capture images of shoplifters or other criminals. As another example, audio-video cameras have been mounted in police vehicles to record both the actions and words of police officers and suspects in or out of other vehicles. Such captured media can provide invaluable evidence to prove the guilt of a suspect or the innocence of a police officer accused of harassment or brutality.

Despite the advantages of such security or surveillance systems to record criminal activity or detect a security breach, these systems are limited by what they capture and in how the captured information is stored, processed, and retrieved. Identification of a person using such systems can be difficult because only an image and/or sound is recorded. Other biometric information is not captured. Further, database information is typically not used in the identification process and, if it is, little or no automation is included.

Conventional security and surveillance systems cannot analyze or process captured media. In general, most conventional systems require human review and analysis. Without an automated analysis component, conventional security and surveillance systems cannot benefit from historical information captured at an earlier date. Further, such systems generally cannot filter relevant information from non-relevant information. In essence, conventional systems are generally non-intelligent in that they are only capture systems.

One important potential use for such security or surveillance systems includes detecting and tracking potential non-friendly individuals or other type of national or corporate enemies. Such security systems could be used at immigration offices in airports or other transportation facilities, or any other location. Nevertheless, as discussed above, conventional systems lack the ability to analyze and process captured information. Without the ability to analyze and process media and other information, these systems cannot easily alert immigration officers to a suspected non-friendly individuals using biometric features, such as, voice, face, fingerprint, etc. matching information previously stored in a database. Further, conventional systems lack automated components that assist in flagging suspected non-friendly individuals.

Another drawback to using conventional security systems to protect homeland security is the wide variety of data types and communication schemes used by different governmental organizations. For example, current applications lack the ability to compile, integrate, and analyze rich media and biometric data. Recently, an individual in Newport News, Virginia, was taken into custody having in his possession ten (10) United States passports in his name, date of birth, and social security number. Conventional systems should flag such redundancy, however limitations in these systems make such results possible.

Particularly in light of the recent dramatic current world events associated with the terrorist attacks of Sep. 11, 2001, there is a need for an improved security and surveillance system that captures, analyzes, and manages information associated with potential threats to homeland security. Further, there is a need for a multi-modal system for and method of capture, analysis, management, and access of disparate types and sources of media, biometric, and database information. Yet further, there is a need to capture more information, analyze the captured information in a more intelligent fashion, and manage the captured information and analysis for retrieval, viewing, managing, comparing, and annotating.

The teachings hereinbelow extend to those embodiments which fall within the scope of the appended claims, regardless of whether they accomplish one or more of the above-mentioned needs.

### SUMMARY OF THE INVENTION

The present invention relates to a system for and method of capture, analysis, management, and access of disparate types and sources of media, biometric, and database information. An exemplary embodiment of the invention can be described as a complete application and integration framework for building a unified and intelligent view of individuals, regardless of data source or type. Such an exemplary embodiment can include (1) a comprehensive capture solution for media, biometric, and database information; (2) a multi-modal analysis system designed to extract, analyze and quickly sort through large volumes of digital information; (3) a web- and client-side user interface providing retrieval, viewing, managing, comparing and annotating of captured information and analysis; and (4) an interface that enables interoperability with third party and in-house databases.

One application of the present invention can be in the context of security or surveillance. Synchronizing information from media capture and processing technologies using an indexing and analysis engine along with facial, positional, voiceprint and other biometric data creates a rich, time-based repository about the individual. The detailed capture, encapsulation, indexing and cataloging of multi-modal information allows security personnel to interact with the system to gain an intelligent and unified perspective. Viewing is further enhanced through skimming technology, allowing, for example, up to an 80% reduction in search and review time of a profile.

An exemplary embodiment relates to a method of capturing, analyzing, managing, and accessing disparate types and sources of media, biometric, and database information. This method can include capturing media, biometric, and database information associated with an individual; processing the media, biometric, and database information to extract, analyze and sort through digital information associated with a number of individuals; and providing a user interface that can be configured to retrieve, view, manage, compare, and annotate the captured information and analysis.

Another exemplary embodiment relates to a system of capturing, analyzing, managing, and accessing disparate types and sources of media, biometric, and database information. This system can include means for capturing media, biometric, and database information associated with an individual; means for processing the media, biometric, and database information to extract, analyze and sort through digital information associated with a number of individuals; and means for providing a user interface that can be configured to retrieve, view, manage, compare, and annotate the captured information and analysis.

Another exemplary embodiment relates to a processing system including a central processing unit (CPU) and a storage device coupled to the CPU and having stored there information for configuring the CPU. The CPU can be configured to capture media, biometric, and database information associated with an individual; process the media, biometric, and database information to extract, analyze and sort through digital information associated with a number of individuals; and provide a user interface that can be configured to retrieve, view, manage, compare, and annotate the captured information and analysis.

Another exemplary embodiment relates to a graphical user interface configured to retrieve, view, manage, compare, and annotate captured media, biometric, and database information associated with an individual and analysis of the information. This graphical user interface can include a first graphical display area on which graphical representations of a first media or biometric capture can be displayed, a second graphical display area on which graphical representations of a second media or biometric capture can be displayed, and a third graphical display area on which graphical representations of a number of individuals matching a search query on media, biometric, or database information are displayed.

Other features and advantages of embodiments of the present invention will become apparent to those skilled in the art upon review of the following drawings, the detailed description, and the appended claims.

### BRIEF DESCRIPTION OF THE DRAWINGS

The invention is illustrated by way of example and not limitation using the figures of the accompanying drawings, in which like references indicate similar elements and in which:

FIG. 1 is a diagrammatic representation of a system for the capture, analysis, and management of disparate types and sources of media, biometric, and database information in accordance with an exemplary embodiment;

FIG. 2 is a diagrammatic representation of a capture system utilized in the system of FIG. 1 in accordance with an exemplary embodiment;

FIG. 3 is a diagrammatic representation of an interact system utilized in the system of FIG. 1 in accordance with an exemplary embodiment;

FIG. 4 is a diagrammatic representation of an analysis system utilized in the system of FIG. 1 in accordance with an exemplary embodiment;

FIG. 5 is a diagrammatic representation of a conversion process utilized in the system of FIG. 1 in accordance with an exemplary embodiment;

FIG. 6 is a flow diagram depicting steps in a method of capturing, analyzing, managing, and accessing disparate types and sources of media, biometric, and database information in accordance with an exemplary embodiment;

FIG. 7 is a flow diagram depicting steps in a method of capturing, analyzing, and managing disparate types and sources of media, biometric, and database information as applied to a government security exemplary embodiment;

FIG. 8 is a flow diagram depicting steps in a method of capturing, analyzing, and managing disparate types and sources of media, biometric, and database information as applied to a corporate security exemplary embodiment;

FIG. 9 is a user interface utilized in the system of FIG. 1 in accordance with an exemplary embodiment;

FIG. 10 is a user interface utilized in the system of FIG. 1 in accordance with an exemplary embodiment; and

FIG. 11 is a table depicting multi-mode factors and captures corresponding to those factors in accordance with an exemplary embodiment.

### DETAILED DESCRIPTION OF EXEMPLARY EMBODIMENTS

A system for and method of capture, analysis, and management of disparate types and sources of media, biometric, and database information are described. In the following description, for purposes of explanation, numerous specific details are set forth to provide a thorough understanding of exemplary embodiments of the invention. It will be evident, however, to one skilled in the art that the invention may be practiced without these specific details. In other instances, structures and devices are shown in diagram form to facilitate description of the exemplary embodiments.

In one embodiment, a computer system is used which has a central processing unit (CPU) that executes sequences of instructions contained in memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

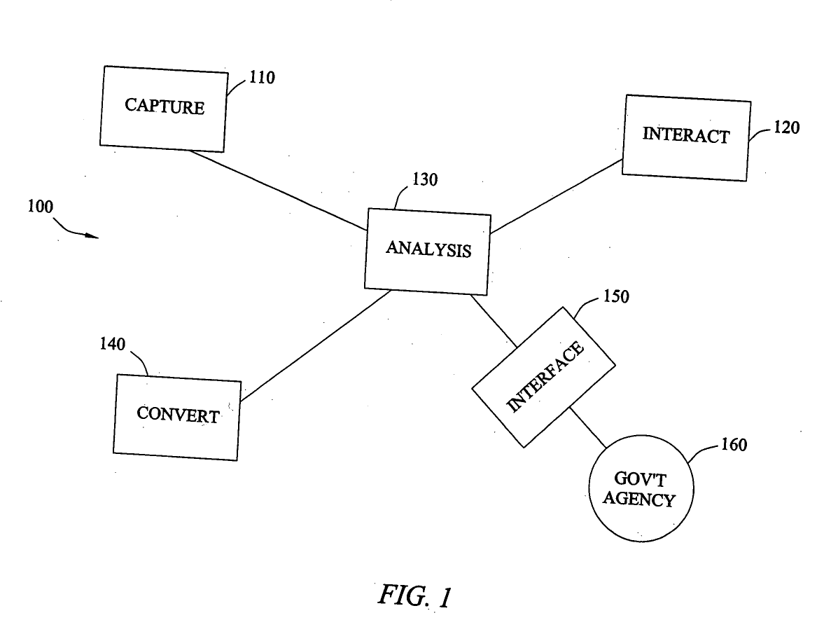

FIG. 1 illustrates a system 100 configured for the capture, analysis, and management of disparate types and sources of media, biometric, and database information. System 100 can include a capture component 110, an interact component 120, an analysis component 130, a convert component 140, and an interface 150. In an exemplary embodiment, system 100 can be configured to communicate via interface 150 to and from a governmental agency database 160. Alternatively, interface 150 can facilitate communications with other databases, such as, a corporate security database or a corporate security database and a governmental homeland security database.

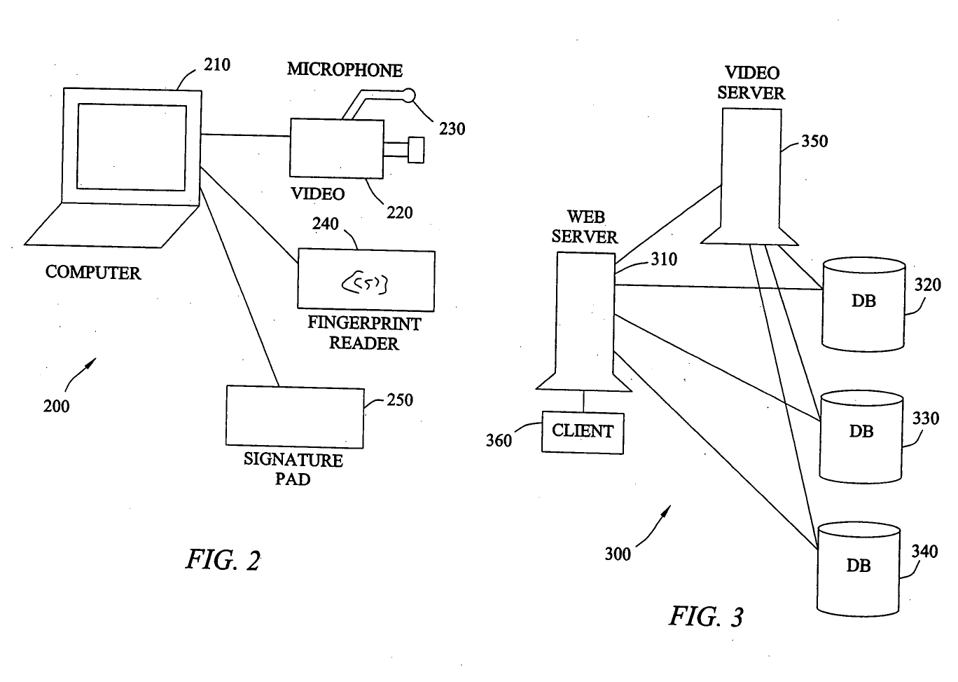

Capture component 110 can be configured to perform the function of capturing content in any of variety of forms, including visual, audio, and multi-media content. Capture component 110 can include any of a variety of multi-modal capture techniques. For example, capture component 110 can include a software video capture of real-time video feed, digital media, or capture from video, audio, face, fingerprint, position, signature, retina, or any other characteristic. Capture component 110 and its associated functionalities are described further with respect to FIG. 2.

Interact component 120 can be configured to perform the function of accessing content, including, for example, searching, retrieving, skimming, annotating, or any other interaction activity involving multi-modal captured content. Interact component 120 can include record retrieval, cross-matching, auto-searching, or navigation among captured content. Interact component 120 and its associated functionalities are described further with respect to FIG. 3.

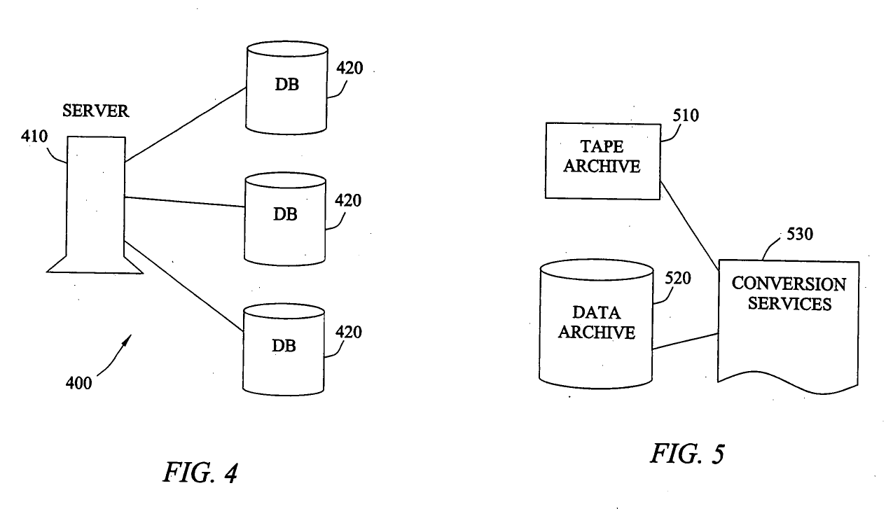

Analysis component 130 can be configured to perform multi-modal feature extraction. Such features can include face ID, voice print, geo-coding, and height. These features can be used for screening, flagging, and matching. Analysis component 130 and its associated functionalities are described further with respect to FIG. 4.

Convert component 140 can include conversion services of multi-modal content. Such conversion can include tape archiving, file archiving, and metadata archiving. Convert component 140 and its associated functionalities are described further with respect to FIG. 5.

Advantageously, system 100 provides for the capture, analysis, and management of disparate types and sources of media, biometric, and database information. System 100 allows for multi-modal capture of information that can be stored and analyzed with previously stored information. Therefore, system 100 allows, by way of example, an immigration officer to capture media and biometric information associated with an individual, have that information stored in a database and compared with previous information associated with the individual of record as well as compared to other individuals with similar media and biometric information, and be alerted when inconsistencies in identity are found or when particular individuals are flagged. The immigration officer does not have to review hundreds of photos or search through names that may not match a bogus name given on a passport. As such, system 100 provides for a more efficient and accurate identity recordation and identification system, helping the immigration officer more appropriately screen individuals desiring to enter the country.

FIG. 2 illustrates a capture system 200. Capture system 200 can include a computer 210, a video camera 220, a microphone 230, a fingerprint reader 240, a signature pad 250, and any other of a variety of capturing mechanisms. As explained with reference to FIG. 1, capture system 200 is part of a system that can capture not only a still image of an individual, but also other salient information (e.g., voice, video, biometrics) that can be used in totality to uniquely define or identify a person. When used together, the various types of captured information can be used to more accurately identify an individual.

Capture system 200 can store media into computer readable files stored in a computer memory which is accessible by a computer. Such files can be stored electronically in any of a variety of data formats, such as, the Moving Picture Experts Group Layer-3 Audio (MP3) audio file format, MICROSOFT wave (WAV) audio file format, Windows Media Audio (WMA) audio file format, or any format which is readable by a computing device, such as, a personal computer (PC) or a hand held personal digital assistant (PDA). Video files can be in DV format, MPEG format, QUICKTIME format, or audio video interleave (AVI) format. Still image files can be in any of a variety of data formats, such as, PMP and Joint Pictures Expert Group (JPEG) format. Furthermore, film, such as, digitized film can also be stored in a computer readable file and accessed by computer.

Computer 210 can be any of a variety of computing devices, including a personal computer (PC), a laptop computer, a handheld device, a personal digital assistant (PDA), a wireless application protocol (WAP) device, or any other computing device. Capturing software can be stored in a memory of computer 210 or in a network that is accessed by computer 210. Computer 210 can be located in immigration booths, police stations, police cruisers, etc.

Computer 210 can receive input from video camera 220, microphone 230, fingerprint reader 240, and signature pad 250 through IEEE 1394 and USB ports. Computer 210 can be configured to receive scanned passport information, gather data from the passport (either via a network or from input by a user), and collect and organize other information. Computer 210 submits information captured or gathered to an analysis component described with reference to FIG. 3. The analysis component can be located either locally or at a central facility.

Video camera 220 can be a PC camera, a digital camera, or any other device that captures both still and motion pictures and can deliver directly or via a media converter (e.g., analog to digital) the pictures to computer 210. Microphone 230 can be integral to or separate from video camera 220. Microphone 230 can be any device capable of receiving and transmitting a captured representation of sound.

Fingerprint reader 240 can be a scanning device upon which an individual places a finger to be scanned. Alternatively, fingerprint reader 240 can be a scanner capable of reading a fingerprint from a passport or other tangible instance, such as, a piece of paper available at an immigration office. Signature pad 250 can be an input device, such as, a touch pad that an individual can use an input pen to sign his or her name on a flat, touch-sensitive pad. The signature is received by computer 210 and stored.

As discussed above, a wide variety of other capturing devices can be utilized with capture system 200. For example, a retinal scanner can be used to capture a representation or image of a person's retina for identification purposes. Other devices can also be used, such as, a hand scanner, a bar code scanner, or other media or biometric capturing mechanisms.

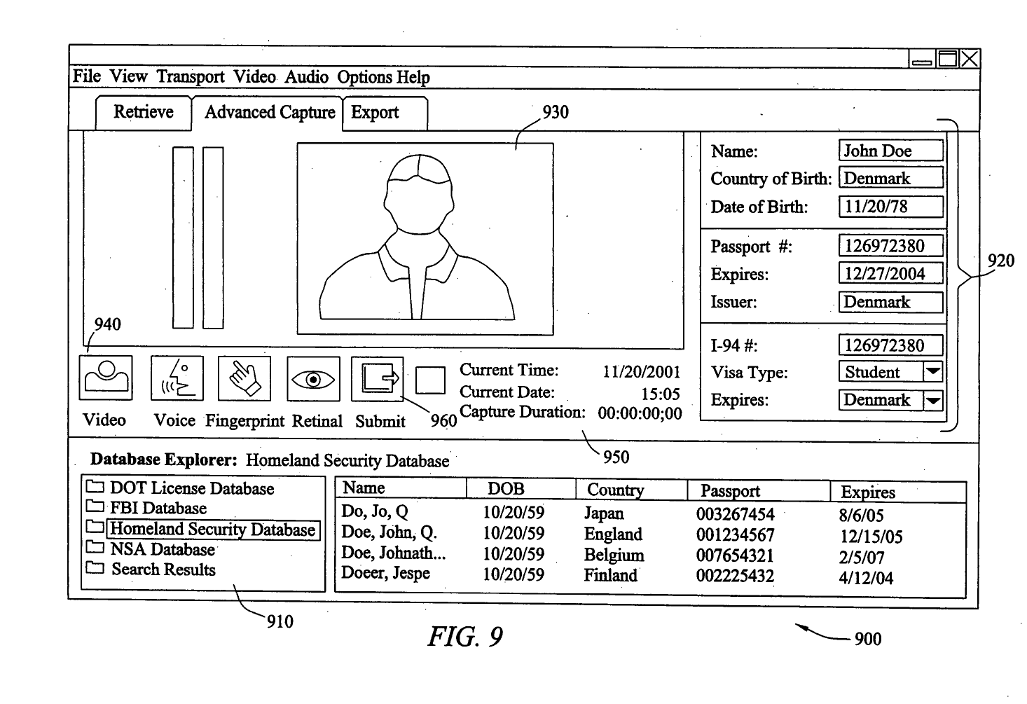

Along with video, audio, or biometric information, capture system 200 can include reference information, such as, global location, time references, passport number, social security number, driver's license number, etc. All capture information, including media, biometric, database, and reference information can be viewed or accessed using a user interface. An example user interfaces is described with reference to FIG. 9.

FIG. 3 illustrates an interact system 300. Interact system 300 can include a web server 310, a database 320, a database 330, a database 340, a video server 350, and a client/browser computer 360. Servers 310 and 350 can be any of a variety of computing devices capable of storing programs and data. Servers 310 and 350 can be configured to communicate with capture systems and analysis systems via a private or public network. Databases 320, 330, and 340 are memory storing information in relational database structures or other such relational system. Three databases are shown here for illustrative purposes only. Databases 320, 330, and 340 can also include server-type devices.

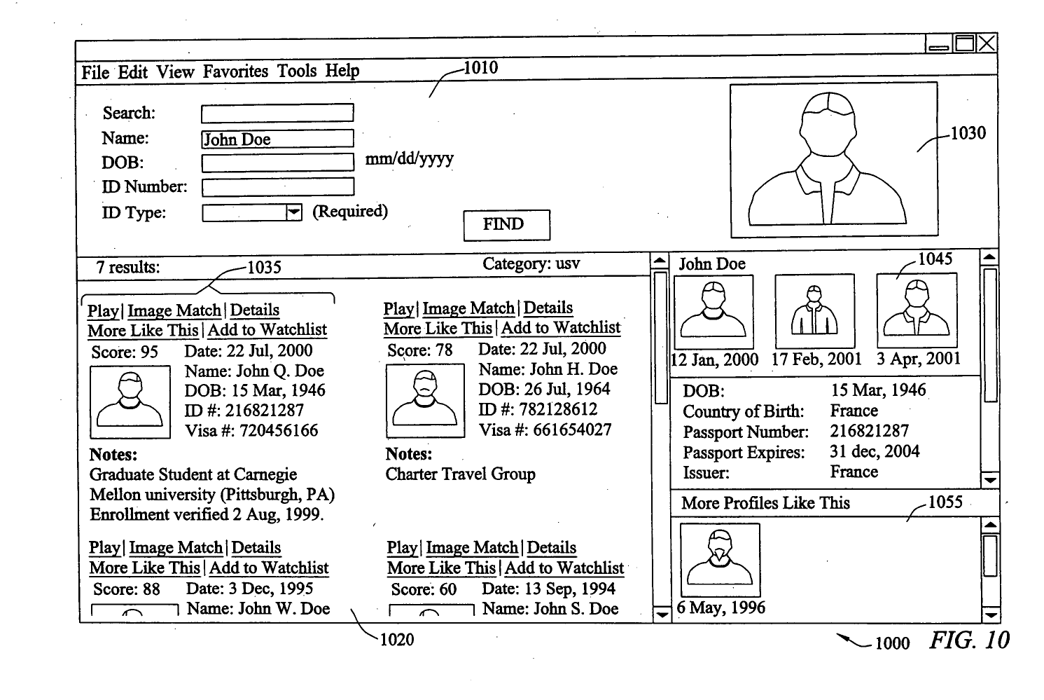

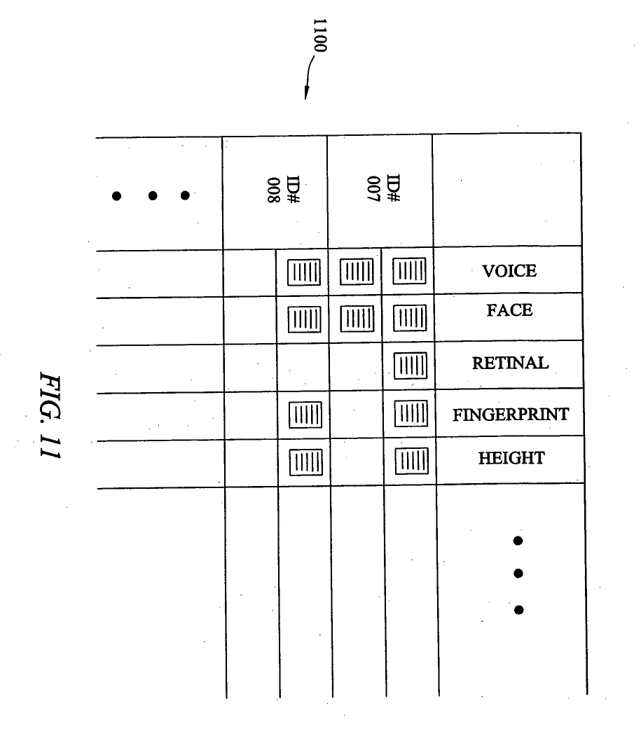

Server 310 provides for functions, such as, access, search and retrieve, present or view, navigate, timeline compare, annotate, and collaborate. Server 310 can provide for a web-based viewer, or, alternatively, for a stand-alone viewer. Where server 310 communicates via a network of computers, secure access can be maintained in a variety of ways. A sample user interface providing a user with some of the functionalities of interact system 300 is described with reference to FIG. 10.

By way of example, interact system 300 provides chronological perspective, record to record compare, image and media retrieval, skimming across multiple records, rapid retrieval, navigation on multi-search criteria, scaleable on secure networks, transfer capabilities, application development tools, and other functions. Advantageously, interact system 300 provides users, such as, an immigration officer with the ability to quickly retrieve information about individual profiles, including a chronological profile that details times and locations of entry into the system.

Interact system 300 can include skimming functionality to skim digital audio and video data. Such skimming can preferably involve portions of multiple files, such as, portions of multiple profile records. One exemplary system and method for skimming is described in U.S. Pat. No. 5,664,227 entitled SYSTEM AND METHOD FOR SKIMMING DIGITAL AUDIO/VIDEO DATA issued to Mauldin et al. on Sep. 2, 1997, and incorporated in its entirety herein by reference.

FIG. 4 illustrates an analysis system 400. Analysis system 400 can include a server 410, a database 420, a database 430, and a database 440. Server 410 can be any of a variety of computing devices capable of storing programs and data, including a web and/or video server. Server 410 can be configured to communicate with capture systems and interact systems via a secure private or public network. Databases 420, 430, and 440 are memory storing information in relational database structures or other such relational system. In most embodiments, server 410 can be the same server as server 310 in interact system 300 described with reference to FIG. 3.

Server 410 provides for functions, such as, integrated speech, language, and image processing. Server 410 also provides for multi-modal analysis, including metrics such as video, audio, speech, biometrics, geo-coding, GPS, and height. Server 410 can provide for indexing, automated analysis, database interfaces, reporting, screening, and flagging.

Indexing and analysis in analysis system 400 can include the system and method described in U.S. Pat. No. 5,835,667 entitled METHOD AND APPARATUS FOR CREATING A SEARCHABLE DIGITAL VIDEO LIBRARY AND A SYSTEM AND METHOD OF USING SUCH A LIBRARY issued to Wactlar, et al. on Nov. 10, 1998 and incorporated in its entirety herein by reference.

Analysis system 400 provides for higher accuracy in identification because multiple modes are used. Conventional systems take one factor or mode, such as, face (e.g., a photograph) and attempt to match that factor with the same factor for millions of individuals. Analysis system 400 takes multiple factors or multiple modes, such as, voice (e.g., a captured sound bite), face (e.g., a photograph), face/voice (e.g., a video clip), retina, and a fingerprint and attempts to match the multiple factors. Advantageously, analysis system 400 has fewer false positives and greater scalability. An exemplary table depicting multi-mode factors and corresponding captures is described with reference to FIG. 11.

Analysis system 400 can process the data sent to it and can extract many features from the data, such as, voice prints for speaker identification, face-identification for face recognition, locations for geo-coding and subsequent mapping, etc. to create a time-synchronized record of the individual. Analysis system 400 can also check for duplicate records within system 100 using any or all of the different aspects of the individual. Advantageously, security personnel can receive immediate feedback if the person is carrying fake documents based on a flag triggered, even if one or more of the features match on a different record. While a name and picture on an identification card can be compromised, a stored individual profile can maintain correct name, face, finger print, voice print and travel patterns. As such, analysis system 400 can extract and organize multiple factors about an individual for easy access and interpretation by law enforcement and other authorized personnel.

FIG. 5 illustrates a convert system 500. Convert system 500 can include a tape archive 510 and a data archive 520 coupled to conversion services 530. Tape archive 510 can include magnetic tapes stored on reels and containing information that may be relevant to the analysis component of system 100. Data archive 520 can include optical memory, magnetic hard disk memory, or any other structure that archives data or metadata.

Conversion services 530 can involve data entry, both manual and automated, from archived and legacy databases, including text and biometric data. Example conversion services can include formatting, transcoding, quality control, indexing, transfer, schema developing, and meta-data conversion.

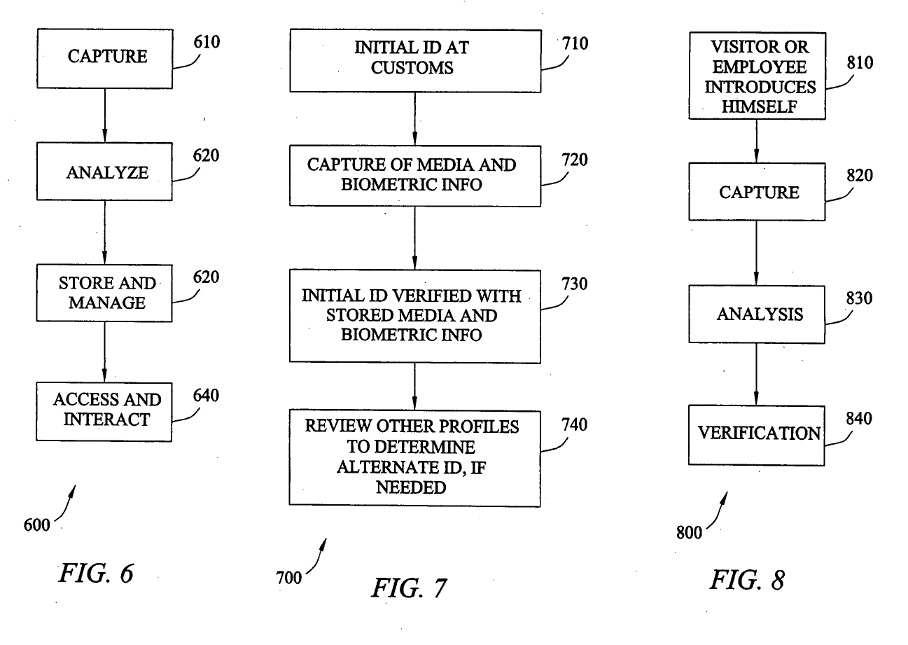

FIG. 6 illustrates a flow diagram 600 of exemplary steps in a method of capturing, analyzing, and managing disparate types and sources of media, biometric, and database information. In a step 610, media and/or biometric data is captured. Media data can include audio and video (still and motion pictures). Biometric data can include information associated with fingerprints, hand prints, retinas, and other physiologic information, including information derived from video and audio data, such as, skin and hair color as well as language and accent.

After information capture, a step 620 is performed in which the captured information is analyzed. Such an analysis can be made with respect to comparables, to reference points, or to stored information. For example, a video clip can be analyzed to extract relevant physical characteristics. The analysis of the captured information can also include a verification of information contained for a particular record and inclusion of the captured information into a historical record for the individual. As such, a record for a particular individual can include multiple instances of captured information including dates and location to track changes in appearance of the individual and in location. Advantageously, the additional information provides even more information to help assess identity, making the individual profile more accurate and more complete. For example, one individual may have a dozen different face images in his or her profile, each depicting a variety of different facial variations (e.g., mustache, beard, bleached hair, glasses).

A step 630 can be performed in which captured information and associated analysis is stored and managed. Management of captured information allows for access and interaction in a step 640 by authorized personnel. Interactions can include searching for individuals based on certain textual clues to retrieve a detailed chronological account of a suspect along with facial imagery, travel history, fingerprints, etc. Advantageously, a composite compilation of related records can be created automatically in a storyboard format on a computer user interface such that security personnel can view profile details. Management of capture information can also include allowing for the annotation of records to append a flag or note for further enhancement of the screening process.

FIG. 7 illustrates a flow diagram 700 of exemplary steps in a method of capturing, analyzing, and managing disparate types and sources of media, biometric, and database information as applied to a government security exemplary embodiment. In a step 710, an individual approaches an immigration officer with a passport having photographic identification and a passport number. The immigration officer scans a bar code on the passport into a customs computer. The immigration computer retrieves relevant information associated with the passport number scanned. The passport number is also passed to system 100 described with reference to FIG. 1 and related profile information is made available. Such information can include media and biometric information accessible via a user interface on the immigration computer.

In a step 720, media and biometric information for the individual is captured. Some information, such as, video and voice can be captured while the immigration officer interviews the individual or while the immigration officer is waiting for the profile to be retrieved and presented on the user interface of the immigration computer. Other information, such as, fingerprint and signature must be provided by the individual upon request by the immigration officer.

In a step 730, captured media and biometric information is analyzed and presented along with historical media and biometric information to the immigration officer using the user interface at the immigration computer. The analysis of the captured information helps the immigration officer to verify the initial identification provided by the passport photograph and passport number. Presenting current captured information along with historical captured information and other data helps to identify conflicts or alert the immigration officer as to the need for more detailed scrutiny of the individual.

In a step 740, the immigration officer can search and review other profiles to determine an alternate identification, if necessary. For example, the analysis provided by the system can identify conflicting factors where the profile of the initial identification (e.g., from the passport) does not match the captured information. These conflicting factors can be searched for a closer match. Alternate profiles can also be presented automatically by the system.

Advantageously, passport information can be verified using current media and biometric information. The captured information can be stored, organized, and managed such that the information available in the profile in increased and improved. For example, identification is managed chronologically using a history of captures, including time and location. Identification matches are more accurate and more meaningful. Immigration officers can also make determinations based on historical media and biometric information unavailable from the face of the passport.

FIG. 8 illustrates a flow diagram 800 of exemplary steps in a method of capturing, analyzing, and managing disparate types and sources of media, biometric, and database information as applied to a corporate security exemplary embodiment. In a step 810, a visitor or an employee to a company presents himself or herself at a reception location. The reception location may include a receptionist having access to a corporate security computer or computer monitor. Alternatively, the reception location is not manned, but includes a communication device, such as, a closed circuit telephone or speaker and microphone combination that allows the visitor or employee to communicate with security personnel or an automated computer system.

In a step 820, media and biometric information for the visitor or employee is captured. Some information, such as, video and voice can be captured while the receptionist asks who the visitor wants to see or what purpose the visitor has with his or her visit. In the situation where employee information is gathered, the employee can be asked how long the employee will be at the location (if the employee is from another corporate office) or other similar questions. Other information, such as, fingerprint and signature must be provided by the visitor or employee upon request by the receptionist.

In a step 830, the media and biometric information is analyzed and processed. In the situation where a receptionist is located at the reception area, captured information and information associated with the analysis can be presented on a user interface. As such, the receptionist can be alerted to conflicts or flags associated with the profile of the visitor or employee. The receptionist or security personnel located at a central security location can conduct searches on the user interface using, for example, various factors including information captured from the visitor or employee.

In a step 840, verification can be made based on a variety of pre-determined factors set by company policy. For example, a company can determine that certain employees with a particular security clearance need to have a certain percentage match to be allowed entry. Similarly, a company can restrict access to visitors based on a registered visitor status that requires a pre-screening process.

Advantageously, the method described with reference to FIG. 8 provides companies with an increased level of security. Most conventional corporate security systems can easily be circumvented by use of a stolen or old number code or security card (e.g., a magnetic ID badge or card). Video surveillance cameras are also used in conventional systems. However, such cameras are often just for recording purposes and are often viewed only by a somewhat attentive security guard. The method described can require that the identity of persons desiring to enter a restricted area be confirmed using captured media and biometric factors. Advantageously, the method allows data from a surveillance camera to be linked to image associated with a security card such that the two images can be compared.

FIG. 9 illustrates a user interface 900 used in the capturing and presentation of media and/or biometric information. User interface can include an explorer window 910, query fields 920, a capture window 930, function buttons 940, a timing window 950, and a submit button 960. Explorer window 910 can facilitate navigation in a database accessible by user interface 900. For example, explorer window 910 can provide access to a homeland security database having a wide variety of different files available. Query fields 920 can allow the user to search the database based on certain identity field. Example fields include name, country of birth, date of birth, passport number, visa type, and other potentially relevant information.

Capture window 930 can present captured media or biometric information as well as information from files accessed using explorer window 910 or query fields 920. Function buttons 940 allow the user to select a type of mode for capturing. For example, the user can select a video mode, a voice mode, a fingerprint mode, or a retinal mode. Other modes can also be provided for. Timing window 950 presents current time information, such as, the current date, current time, and capture duration. Submit button 960 communicates a capture for feature extraction and matching.

FIG. 10 illustrates a user interface 1000 used with the interact component of system 100 described with reference to FIG. 1. User interface 1000 can include search query fields 1010, a search result window 1020, and a selected search results window 1030. Search query field 1010 allows a user to select search keywords, a search scope, and the types of matches.

Search results window 1020 presents results from the conducted search. In an exemplary embodiment, results are shown in search results window 1020 using thumbnail pictures, hyperlink functions, and a brief description. The thumbnail pictures provides a still image that the user can reference to identify the content of a particular search hit. The hyperlink functions provide for functions that can be conducted on a per-result fashion. For example, hyperlink functions can include play, image match, details, more like this, and add to watchlist. The more like this function allows the user to search more results similar to this result. Search results window 1020 can include view bars 1035 that visually identify the type (e.g., video, audio, biometric) of results displayed in selected search result window 1020.

Selected search result window 1030 provides for a video clip to be presented. Selected search result window 1030 also includes a storyboard 1045 of multiple thumbnails associated with the result. In the situation where user interface 1000 is used for security, storyboard 1045 can present multiple images of the same identified individual over time, possibly having various different appearances. Selected search result window 1030 can also include an area for presenting results from a more profiles like this search.

Advantageously, in an exemplary security embodiment, user interface 1000 allows the user to view currently captured information along with historically captured information. Further, the user can compare several different profiles based on a variety of different search criteria. The user can search from among the results found in the search as well as add search results to a watch list.

FIG. 11 illustrates a table 1100 depicting multi-mode factors and captures corresponding to those factors. Table 1100 includes several rows arranged or identified by a identification number, such as, a passport or social security number or combination. Table 1100 includes columns corresponding to several different modes, such as, voice, face, retinal, fingerprint, and height. Additional or fewer modes can also be present. Table 1100 is used for illustration purposes and can be implemented using relational databases in a variety of ways.

Table 1100 can be populated with files containing captured media and biometric information associated with individual profiles. In an analysis of newly captured information, table 1100 can be used to compare the metrics stored with the newly captured metrics. For example, an individual having an identification number of 007 is captured on video and using a fingerprint scanner. This captured information is compared with the information stored for the face, voice, face/voice, and fingerprint categories in table 1100.

Advantageously, using more than one metric reduces the number of false positives identified during an analysis. Further, keeping captured information on the multiple metrics provides multiple captures with which to compare the newly captured information, making the comparison even more accurate. Thus, each record in table 1100 represents a new capture.

Advantageously, the system and method described with reference to the FIGURES provides for a variety of applications. For example, the system and method provides for an improved ability to capture, analyze, and manage disparate types and sources of media, biometric, and database information. As such, the identities of persons desiring entry into a country or a corporate facility can be more easily and accurately made. At the same time, media and biometric information is captured and added to the database, providing a record of the individuals media and biometric characteristics as well as his location at certain times.

In one application, homeland security can be improved by providing a point of entry system that automatically verifies identities based on a wide variety of factors, some of which (like biometric factors) cannot be easily changed or compromised. The system and method described with reference to the FIGURES also consolidates into one common view disparate identification information. The system and method also facilitates the analysis and management of the information. As such, security can be improved by ever improving the data taken and making that data available at the point of entry in an intelligent fashion.

While the embodiments illustrated in the FIGURES and described above are presently preferred, it should be understood that these embodiments are offered by way of example only. Other embodiments may include additional procedures or steps not described here. Other applications not specifically discussed here (e.g., the inclusion of the system in a public or private school or at a voting place) may also be included. The invention is not limited to a particular embodiment, but extends to various modifications, combinations, and permutations that nevertheless fall within the scope and spirit of the appended claims.

What is claimed is:

1. A method of capturing, analyzing, managing, and accessing disparate types and sources of media, biometric, and database information, the method comprising:
capturing media, biometric, and database information associated with an individual;
processing the media, biometric, and database information to extract, analyze and sort through digital information associated with a number of individuals; and
providing a user interface that can be configured to retrieve, view, manage, compare, and annotate the captured information and analysis.

2. The method of claim 1, wherein the media, biometric, and database information includes a facial image, voice audio, or fingerprint.

3. The method of claim 1, further comprising including time information with the captured media, biometric, and database information associated with an individual to create a multi-modal chronological dossier of the individual.

4. The method of claim 1, further comprising forming a summary profile that is an abstract including intelligent portions of various captures of media, biometric, and database information associated with the individual.

5. The method of claim 4, further comprising selectively presenting the summary profile in the user interface.

6. The method of claim 5, wherein the selective presentation of the summary profile in the user interface is in response to a search query.

7. The method of claim 1, further comprising providing for a user-defined search of digital information associated with a number of individuals.

8. The method of claim 7, further comprising conducting a more like this search when a search result from the user-defined search of digital information associated with a number of individuals is explored.

9. The method of claim 8, wherein the more like this search uses speech, facial, and other biometric information to find matches.

10. The method of claim 1, wherein capturing media, biometric, and database information associated with an individual includes using a video camera to capture audio and moving pictures of the individual.

11. The method of claim 1, wherein processing the media, biometric, and database information to extract, analyze and sort through digital information associated with a number of individuals includes analyzing the media, biometric, and database information with respect to identification factors.

12. The method of claim 1, wherein processing the media, biometric, and database information to extract, analyze and sort through digital information associated with a number of individuals includes comparing captured media, biometric, and database information of a first individual with media, biometric, and database information of a number of categorized individuals to find a best match.

13. The method of claim 1, further comprising displaying video thumbnails of video images of the number of individuals on the user interface.

14. A system of capturing, analyzing, managing, and accessing disparate types and sources of media, biometric, and database information, the system comprising:
means for capturing media, biometric, and database information associated with an individual;
means for processing the media, biometric, and database information to extract, analyze and sort through digital information associated with a number of individuals; and
means for providing a user interface that can be configured to retrieve, view, manage, compare, and annotate the captured information and analysis.

15. The system of claim 14, further comprising means for including time information with the captured media, biometric, and database information associated with an individual to create a multi-modal chronological dossier of the individual.

16. The system of claim 14, further comprising means for forming a summary profile that is an abstract including intelligent portions of various captures of media, biometric, and database information associated with the individual.

17. The system of claim 16, further comprising means for selectively presenting the summary profile in the user interface.

18. The system of claim 17, wherein the means for selectively presenting the summary profiled in the user interface operates in response to a search query.

19. The system of claim 14, further comprising means for providing for a user-defined search of digital information associated with a number of individuals.

20. The system of claim 19, further comprising means for conducting a more like this search when a search result from the user-defined search of digital information associated with a number of individuals is explored.

21. A processing system comprising:
a central processing unit (CPU); and
a storage device coupled to the CPU and having stored there information for configuring the CPU to:
capture media, biometric, and database information associated with an individual;
process the media, biometric, and database information to extract, analyze and sort through digital information associated with a number of individuals; and
provide a user interface that can be configured to retrieve, view, manage, compare, and annotate the captured information and analysis.

22. The system of claim 21, further comprising a presentation device, wherein the presentation device is configured to provide a graphical user interface which presents representations of the captured media, biometric, and database information associated with the individual.

23. The system of claim 21, further comprising an interface device configured to connect the CPU with a network of computers.

24. The system of claim 21, wherein the CPU is further configured to assign timing information to the captured media, biometric, and database information associated with the individual.

25. The system of claim 21, wherein the CPU is further configured to form a summary profile that is an abstract including intelligent portions of various captures of media, biometric, and database information associated with the individual.

26. A graphical user interface configured to retrieve, view, manage, compare, and annotate captured media, biometric, and database information associated with an individual and analysis of the information, the graphical user interface comprising:
a first graphical display area on which graphical representations of a first media or biometric capture can be displayed;
a second graphical display area on which graphical representations of a second media or biometric capture can be displayed; and
a third graphical display area on which graphical representations of a number of individuals matching a search query on media, biometric, or database information are displayed.

27. The graphical user interface of claim 26, further comprising a fourth graphical display area on which a storyboard series of images can be displayed.

28. The graphical user interface of claim 26, wherein graphical representations on the third graphical display area include thumbnails of video images of the number of individuals on the user interface.

29. The graphical user interface of claim 28, wherein the graphical representations on the third display area include a more like this search option.

30. The graphical user interface of claim 29, wherein the wherein the more like this search option engages a search involving speech, facial, and other biometric information to find matches.
